(19) United States
(12) Patent Application Publication
(10) Pub. No.: US 2005/0273795 A1
(43) Pub. Date: Dec. 8, 2005

(54) Disc-loading roll

(75) Inventors: Masao Tsukada, Yokohama-shi (JP); Satoko Ogasawara, Yokohama-shi (JP); Takahiro Kiriyama, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: HOKUSHIN CORPORATION

(21) Appl. No.: 11/142,376

(22) Filed: Jun. 2, 2005

(30) Foreign Application Priority Data
Jun. 3, 2004 (JP) 2004-166439
Feb. 14, 2005 (JP) 2005-036849
Feb. 14, 2005 (JP) 2005-036850
Feb. 14, 2005 (JP) 2005-036851

(51) Int. Cl. G11B 17/04

(52) U.S. Cl. 720/624

(57) ABSTRACT

A disc-loading roll is composed of a rubber elastic body formed by use of a mold and having a cylindrical outer surface whose diameter changes along an axial direction. The disc-loading roll comes into contact with a peripheral edge portion of a disc so as to load the disc. An outer circumferential surface of the roll is an irregular surface which is formed by means of the mold. The irregular surface has a ten-point mean roughness Rz of 0.5 to 10 μm and a mean irregularity interval Sm of 15 μm or less.

### CROSS REFERENCE TO RELATED APPLICATION

The entire disclosure of Japanese Patent Application No. 2004-166439 filed on Jun. 3, 2004, Japanese Patent Application No. 2005-036849 filed on Feb. 14, 2005, Japanese Patent Application No. 2005-036850 filed on Feb. 14, 2005 and Japanese Patent Application No. 2005-036851 filed on Feb. 14, 2005, including specification, claims, drawings and summary, is incorporated herein by reference in its entirety.

### BACKGROUND OF THE INVENTION

1. Field of the Invention

The present invention relates to a disc-loading roll which is used for transporting a disc, such as a magneto-optical disc or an optical disc (e.g., CD, LD, DVD), which is used with audio equipment, information equipment, video equipment, etc. More particularly, the present invention relates to a disc-loading roll which has solved a problem that the disc-loading roll causes slippage due to dust particles, such as sand particles, adhering to a disc, and thus fails to load or eject the disc.

2. Related Art

Conventionally, a pair of opposed loading roll assemblies have been used so as to set a magneto-optical disc or an optical disc (e.g., CD, LD, DVD) on a turntable within an apparatus. For example, as shown in FIG. 13, a disc-loading roll assembly is composed of two disc-loading rolls 1 and a shaft 2 penetrating the centers of the disc-loading rolls 1. A similar disc-loading roll assembly is disposed in opposition to the disc-loading roll assembly. One of these disc-loading roll assemblies is rotated. Further, each disc-loading roll 1 has a shape such that its diameter gradually decreases from the outer end to the inner end thereof, so that a disc 3 to be loaded is supported by the loading rolls 1 at a circumferential edge portion thereof, and undergoes centering.

When the disc 3 is inserted between the paired loading roll assemblies, one of the loading roll assemblies is rotated. As a result, the disc 3 is transported to the interior of the apparatus while being nipped between the paired loading roll assemblies. When the disc 3 abuts against a wall provided at the deepest position, movement of the disc 3 and rotation of the loading rolls 1 stops, and only the shaft 2 rotates, and the disc 3 is then placed on the turntable.

Further, there has been developed a loading mechanism as shown in FIG. 14, in which instead of paired loading roll assemblies, a resin plate 4 and a loading roll assembly having loading rolls 1 are provided, and a disc 3 is inserted between the resin plate 4 and the loading roll assembly.

However, such conventional loading rolls have a drawback in that dust particles, especially sand particles, adhering to the disc 3 are transferred to the roll surfaces, and accumulate on the roll surfaces during long-term use, whereby transporting torque for transporting the disc becomes insufficient.

In view of the above, the present inventors have proposed a loading roll which has an irregular surface having a surface roughness Rmax of 20 μm or greater (see Japanese Patent Application Laid-Open (kokai) NO. 2002-313003 (claims, etc.)).

Although the proposed loading roll is effective because of the large surface roughness, a pattern for forming large irregularities must be formed on the inner surface of a mold. Therefore, the conventional disc-loading roll has a drawback of low productivity and is unsuitable for mass production.

### SUMMARY OF THE INVENTION

In view of the foregoing, an object of the present invention is to provide a disc-loading roll which prevents considerably lowering of transporting torque even when dust particles, especially sand particles adhere to the roll during long-term use, to thereby enable reliable performance of loading and ejection.

According to the present invention, which achieves the above object, there is provided a disc-loading roll composed of a rubber elastic body formed by use of a mold and having a cylindrical outer circumferential surface whose diameter changes along an axial direction, the disc-loading roll coming into contact with a peripheral edge portion of a disc so as to load the disc, wherein the outer circumferential surface of the roll is an irregular surface which is formed by means of the mold, and the irregular surface has a ten-point mean roughness Rz of 0.5 to 10 μm and a mean irregularity interval Sm of 15 μm or less.

Preferably, the irregular surface has a mean area maximum height Ry of 4 to 18 μm.

Preferably, the irregular surface has a material ratio tp of 16% or less at a slice level of 20%, and 26% or less at a slice level of 30%.

Preferably, the ratio of a surface area of the irregular surface to an apparent surface area of the roll surface determined under the assumption that the roll surface is a mirror-finished surface is higher than 1.9.

Preferably, the rubber elastic body has a Shore A hardness of 30 to 90°.

### BRIEF DESCRIPTION OF THE DRAWINGS

FIGS. 1 to 6 are views each showing a state in which a disc-loading roll of the present invention is transporting a disc;

FIGS. 7A and 7B are photographs showing the surface conditions of Example 1 of the present invention and those of Comparative Example 1;

FIG. 8 is a graph showing results of Test Example 3;

FIGS. 9A and 9B are photographs showing the surface conditions of Example 2 of the present invention and those of Comparative Example 2;

FIG. 10 is a graph showing results of Test Example 4;

FIGS. 11A and 11B are photographs showing the surface conditions of Example 5 of the present invention and those of Comparative Example 3;

FIGS. 12A and 12B are photographs showing the surface conditions of Example 10 of the present invention and those of Comparative Example 5;

FIG. 13 is a view showing a state of use of disc-loading rolls; and

FIG. 14 is a view showing another state of use of disc-loading rolls.

### DETAILED DESCRIPTION OF PREFERRED EMBODIMENTS

The disc-loading roll of the present invention has a rubber surface having appropriate irregularity. Therefore, even when adhering to the surface, sand particles or other dust particles move down to valley portions of the surface, and the rubber surface comes into direct contact with the disc. This surface shape prevents considerable lowering of the transporting torque.

The irregular surface of the disc-loading roll of the present invention has a ten-point mean roughness Rz of 0.5 to 10 μm, preferably 0.5 to 5 μm, and has a mean irregularity interval (mean width of the profile elements) Sm of 15 μm or less, preferably 10 μm or less. Furthermore, the mean irregularity interval Sm is preferably higher than 1 μm.

The ten-point mean roughness Rz and the mean irregularity interval Sm are specified by JIS B 0601-1994 and may be determined by means of a microscope for measurement of surface profile or a similar instrument.

The ten-point mean roughness Rz is the sum of the mean height of the five highest profile peaks and the mean depth of the five deepest profile valleys measured from the mean line over a sampling length of a roughness profile curve, the height and the depth being measured along the direction perpendicular to the mean line. The mean irregularity interval (mean width of the profile elements) Sm is the mean value of irregularity intervals, each being the sum of the width of a certain profile peak and the width of the adjacent valley as measured along the mean line over a sampling length of a roughness profile curve.

As described above, in the disc-loading roll of the present invention, the surface has relatively small but appropriately sized irregularities as defined by the above range of Rz, and the irregularities are formed at a pitch such that the interval of the irregularities is 15 μm or less, preferably 10 μm or less.

The effect of the present invention—i.e., prevention of lowering of transporting torque—is considered to be attributed to the irregular surface as described above, which enables sand particles or other dust particles adhering to the surface to move down to valley portions of the surface and thus enables the rubber surface to come into direct contact with the disc at all times.

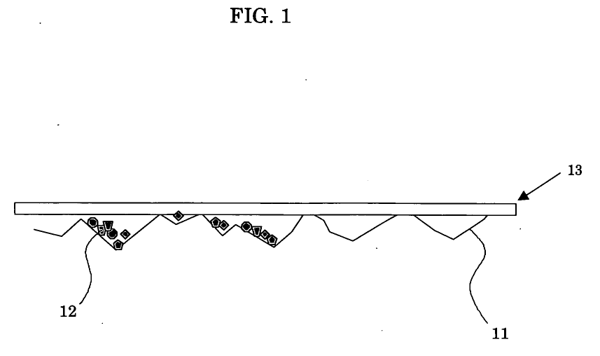

FIG. 1 schematically shows the disc-loading roll which is loading a disc. As shown, dust particles 12 adhering to the surface of the disc-loading roll 11 are caught by a disc 13 and moved down to valley portions of the surface. This enables the surface of the disc-loading roll 11 to come into direct contact with the disc 13. Thus, sufficient force for gripping the disc is successfully obtained.

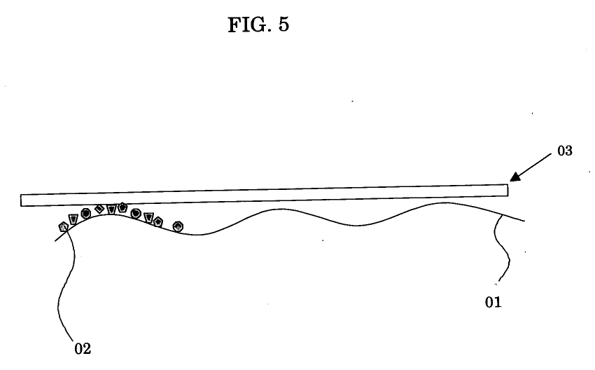

FIG. 5 shows a disc-loading roll 01 which also has an irregular surface. The irregularity height of the disc-loading roll 01 is similar to that of the disc-loading roll shown in FIG. 1, but the mean irregularity interval Sm of the disc-loading roll 01 is larger than 15 μm. In this case, dust particles 02 adhering to the surface of the disc-loading roll 01 tend to remain between the peak portions of the disc-loading roll 01 and a disc 03. This results in insufficient gripping force.

Preferably, the irregular surface of the disc-loading roll of the present invention, which surface is formed by use of a mold, has a mean area maximum height Ry of 4 to 18 μm, more preferably 6 to 18 μm.

The area maximum height Ry is generally defined on the basis of JIS B 0601-1994 and may be measured by means of a microscope for measurement of surface profile or a similar instrument. The area maximum height Ry is determined through the following steps: designating an area on an image; measuring surface roughness over the designated area; and calculating the sum of the height of the highest peak as measured from a reference plane and the depth of the deepest trough as measured from the reference surface. That is, the area maximum height Ry is determined through use of surface roughness data at all points in the range of measurement of a roughness profile surface (=measurement area). Notably, the “reference plane” is determined by use of the height data through the method of least squares.

That is, the irregular surface of a disc-loading roll according to a second embodiment of the present invention has relatively small but appropriately sized irregularities as defined by the above Rz range. However, the irregular surface has relatively high peaks and deep valleys (i.e., a mean area maximum height Ry of 4 to 18 μm), and irregularities are formed at a pitch such that the average interval of the irregularities is 15 μm or less, preferably 10 μm or less. Since the mean area maximum height Ry is large (4 to 18 μm), the degree of irregularity is high, so that rubber surface (peak portions) is hardly covered by dust particles or is covered by a reduced number of dust particles. Further, even when dust particles or the like adhere to the surface, gripping force does not decrease, because the peak portions are highly likely to be exposed to the outside.

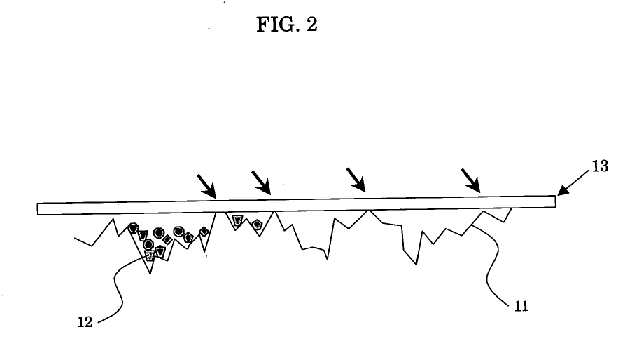

FIG. 2 is a schematic view showing a loading state of a disc-loading roll according to the second embodiment. The surface of the disc-loading roll 11 is less likely to be covered with dust particles. Even when dust particles 12 adhere to the surface of the disc-loading roll 11, the dust particles are scraped and moved to valley portions by a disc 13. Therefore, the disc 13 comes into direct contact with the surface of the disc-loading roll 11 (see arrows in FIG. 2), and sufficient gripping force can be obtained at all times.

Preferably, the irregular surface of the disc-loading roll of the present invention, which surface is formed by use of a mold, has a material ratio tp of 16% or less at a slice level of 20%, and 26% or less at a slice level of 30%. More preferably, the irregular surface of the disc-loading roll of the present invention has a material ratio tp of 6% or less at a slice level of 20%, and 12% or less at a slice level of 30%. Furthermore, the material ratio tp is preferably higher than 2% at a slice level of 20%, and higher than 4% at a slice level of 30%.

The material ratio tp is defined by JIS B 0601-1994 and may be measured by means of a microscope for measurement of surface profile or a similar instrument. The material ratio tp is represented by the following equation, and is determined through the steps of sampling a roughness profile curve over a reference length (L) along the direction of an average line, slicing the sampled portion of the roughness profile at a slice level parallel to the peak line so as to obtain sliced lengths (b1, b2, . . . , bn), and obtaining a percent ratio of the sum (material length np) of the sliced lengths (b1, b2, . . . , bn) to the reference length.
tp (%)=(np/L)×100
np: b1+b2+ . . . bn
L: reference length

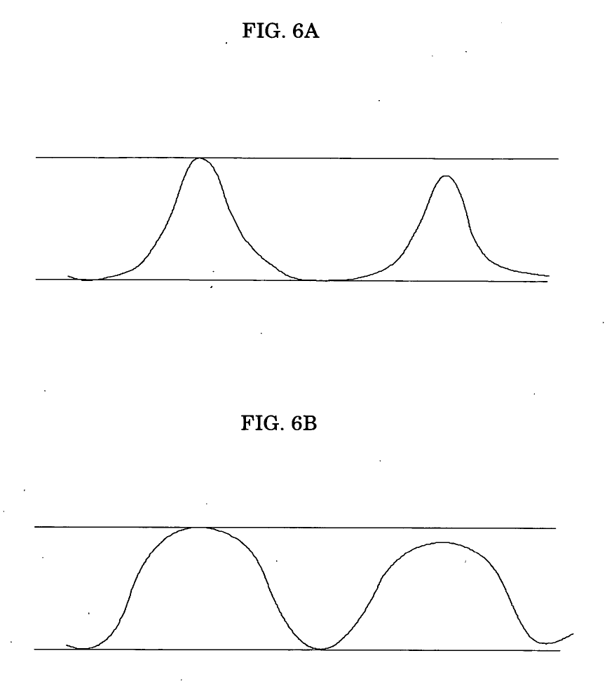

When the material ratio tp is 16% or less at a slice level of 20%, and 26% or less at a slice level of 30%, as shown in FIG. 6A, the irregular surface of the disc-loading roll of the present invention has sharpened peaks. In contrast, even when the values of Rz or Sm are substantially the same, if the value of tp falls outside the above-described range, as shown in FIG. 6B, the irregular surface of the disc-loading roll has broad peaks.

That is, the irregular surface of a disc-loading roll according to a third embodiment of the present invention has relatively small but appropriately sized irregularities as defined by the above Rz range. However, irregularities are formed at a pitch such that the average interval of the irregularities is 15 μm or less, preferably 10 μm or less, and the material ratio tp is equal to or less than a predetermined value. In particular, since the material ratio tp is 16% or less at a slice level of 20%, and 26% or less at a slice level of 30%, peak portions, especially, top portions of the peak portions, each assume a sharpened shape. As a result, the spaces or valleys in which dust particles fall are widened, and dust particles become more likely to fall in the valleys.

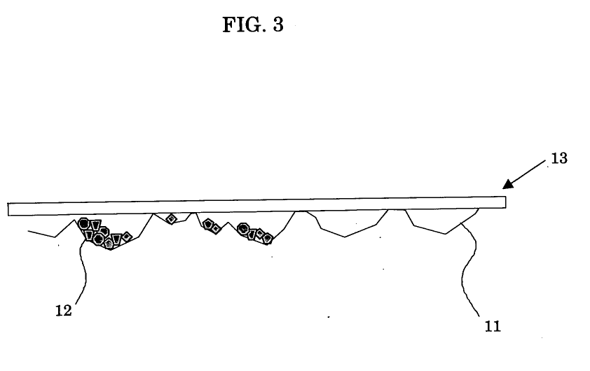

FIG. 3 is a schematic view showing a loading state of a disc-loading roll according to the third embodiment. Dust particles 12 adhering to the surface of the disc-loading roll 11 are scraped and moved to valley portions by the disc 13. Therefore, the disc 13 comes into direct contact with the surface of the disc-loading roll 11, and sufficient gripping force can be obtained at all times.

Preferably, the irregular surface of the disc-loading roll of the present invention, which surface is formed by use of a mold, has a surface area whose ratio to an apparent surface area of the roll surface determined under the assumption that the roll surface is a mirror-finished surface is higher than 1.9, more preferably, equal to or higher than 2.1. Furthermore, the ratio of a surface area of the irregular surface to an apparent surface area of the roll surface determined under the assumption that the roll surface is a mirror-finished surface is preferably 5.0 or less, more preferably 3.0 or less.

The ratio of the surface area to the apparent surface area (hereinafter referred to as “reference area”) of the roll surface determined under the assumption of the roll surface being a mirror-finished surface; i.e., the ratio of the surface area to the reference area, can be obtained from the “surface area” and the “reference area.” Actually measuring the “reference area” is ideal. However, in the case where an area of interest is small as compared with the entire roll, the area can be considered as a flat surface rather than a curved surface, and therefore, the area of a disc-loading roll surface as viewed from above can be considered the “reference area.” The “surface area” is an actual surface area of a portion having the reference area. The higher the ratio of the surface area to the reference area, the greater the surface area of the disc-loading roll, because of formed irregularities.

That is, the irregular surface of a disc-loading roll according to a fourth embodiment of the present invention has relatively small but appropriately sized irregularities as defined by the above Rz range. However, irregularities are formed at a pitch such that the average interval of the irregularities is 15 μm or less, preferably 10 μm or less, and the ratio of the surface area to the reference surface is higher than 1.9; that is, because of the formed irregularities, the surface area becomes greater than 1.9 times the apparent surface area of the roll surface determined under the assumption of the roll surface being a mirror-finished surface. In particular, since the ratio of the surface area to the reference surface is higher than 1.9, even when dust particles or the like adhere to the surface, gripping force does not decrease, because the peak portions are highly likely to be exposed to the outside.

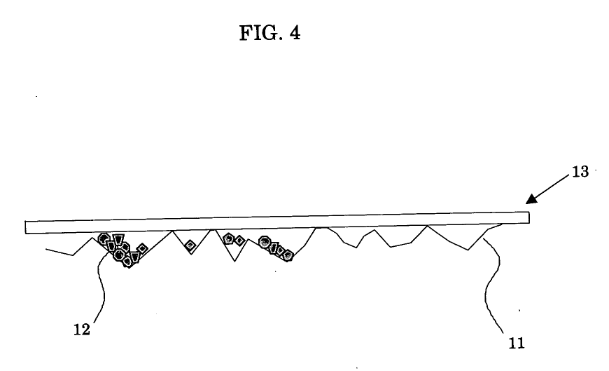

FIG. 4 is a schematic view showing a loading state of a disc-loading roll according to the fourth embodiment. Dust particles 12 adhering to the surface of the disc-loading roll 11 are scraped and moved to valley portions by the disc 13. Therefore, the disc 13 comes into direct contact with the surface of the disc-loading roll 11, and sufficient gripping force can be obtained at all times.

The irregular surface of the disc-loading roll of the present invention is formed through molding by use of a mold. No limitation is imposed on the method of forming, on the inner surface of the mode, a pattern for forming the irregular surface. Other than mechanical machining such as sand blasting or shot blasting, chemical processes such as etching can be used to form a desired irregular surface simply and at low cost.

In an example method of forming the above-mentioned irregular surface on a mold, a predetermined medium is blasted against a mold which is formed by cutting steel material having a hardness of 38 (HRC) or higher. In this case, blasting is preferably performed by use of angular media particles (sand) having a grain size of 50 to 300 μm and a variation of ±10% at the reference grain size. A mold having a desired irregularity can be formed through adjustment of the grain size of media particles to be used and blasting conditions. Preferably, the surface having undergone the above-described processing is covered with hard chromium plating.

The disc-loading roll of the present invention can be formed by use of EPDM, silicone, chloroprene, NBR, or the like.

The disc-loading roll of the present invention typically has a Shore A hardness of 30 to 90°. However, the disc-loading roll preferably has a Shore A hardness of 40 to 60°, in order to obtain sufficient transporting torque.

As described above, the disc-loading roll of the present invention has a predetermined irregular surface. Therefore, even when dust particles adhere to the disc-loading roll, the dust particles fall in valley portions, so that the disc-loading roll can be used in a stable condition, over a long period of time, with no substantial decrease in transporting torque.

### EXAMPLES

The present invention will now be described by way of examples; however, the present invention is not limited thereto.

### Example 1

A cylindrical body was molded from silicone rubber (100 parts by weight) by use of a predetermined mold. Specifically, the silicone rubber was subjected to vulcanization performed at 170° C. for 8 min by use of a heating press, whereby the cylindrical body having a Shore A hardness of 50° was obtained. The cylindrical body was then cut off to thereby obtain a disc-loading roll of Example 1.

### Comparative Example 1

Molding was performed by use of a rubber material similar to that used in Example 1 and a mold having a mirror-like inner surface to thereby obtain a disc-loading roll of Comparative Example 1.

### Test Example 1

The surface conditions of the outer surfaces of the disc-loading rolls of Example 1 and Comparative Example 1 were measured in the following manner.

A VIOLET LASER COLOR 3D PROFILE MICROSCOPE of Keyence Corporation (controller section: VK-9500, measuring section: VK-9510) was used as a measurement instrument. The measurement was performed under the following conditions.
Magnification: 3000×(objective 150×20)
Optical zoom: 1×
Color super depth
Measurement distance: 50 μm
Pitch: 0.05 μm
Height smoothing: ±2
Surface inclination correction: none
Cut off value: 0.08 mm

For each sample, sampling data were acquired at five locations, and the mean value was obtained.

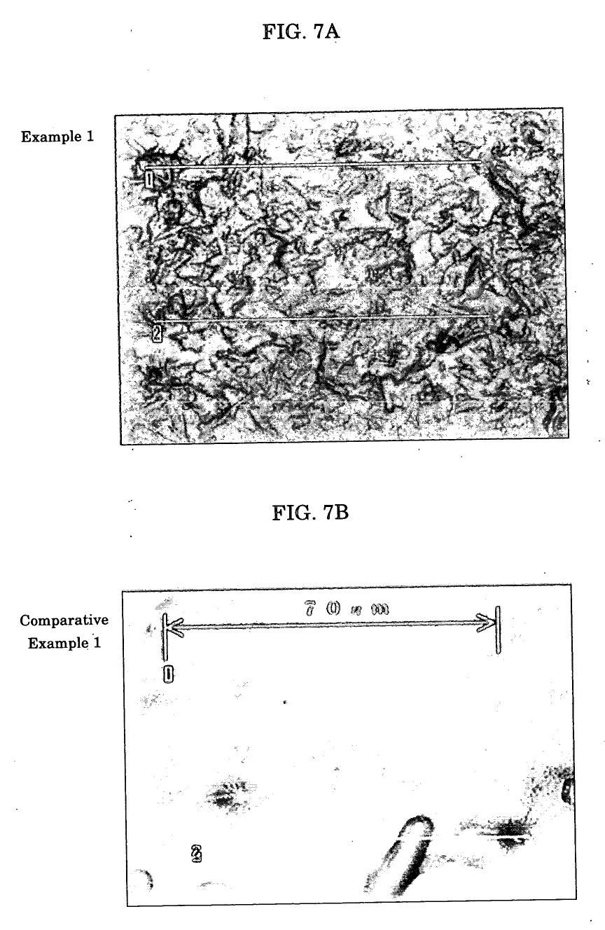

The results are shown in Table 1. Further, photographs (3000×) of surfaces are shown in FIGS. 7A and 7B.

The results show that whereas the loading roll of Comparative Example 1 has gentle irregularities, the loading roll of Example 1 has a small irregularity interval; i.e., Comparative Example 1 and Example 1 have different surface conditions. The results clearly show that between Comparative Example 1 and Example 1 no difference is present in surface roughness Rz, but a significant difference is present in mean irregularity interval Sm.

TABLE 1

| | |
|---|---|
| Rz | Sm |

| | Ex. 1 | Comp. Ex. 1 | Ex. 1 | Comp. Ex. 1 |
|---|---|---|---|---|
| 1 | 1.17 | 1.40 | 8.61 | 29.79 |
| 2 | 1.31 | 0.70 | 2.11 | 11.68 |
| 3 | 1.10 | 0.35 | 10.63 | 18.37 |
| 4 | 1.17 | 2.18 | 5.45 | — |
| 5 | 1.32 | 1.10 | 8.12 | 25.56 |
| 6 | 1.42 | 3.73 | 15.55 | — |
| 7 | 1.17 | 0.81 | 8.61 | 5.41 |
| 8 | 1.31 | 4.86 | 2.11 | — |
| 9 | 1.24 | 1.12 | 6.64 | 27.89 |
| 10 | 0.91 | 1.85 | 4.79 | 22.17 |
| Mean | 1.21 | 1.81 | 7.26 | 20.12 |
| Max | 1.42 | 4.86 | 15.55 | 29.79 |
| Min | 0.91 | 0.35 | 2.11 | 5.41 |

“—” indicates that measurement was impossible because of absence of irregularity

### Test Example 2

Each of the disc-loading roll of Example 1 and Comparative Example 1 was assembled in an apparatus placed in the environment of the below-described dust test method, and the apparatus was caused to repeatedly perform loading and eject operations. The results are shown in Table 2.

Dust test method (JIS D 0207 (floating test F-3))

Dust type: JIS Z 8901, 8 types
   Dust concentration: 100 mg/m³ or higher
   Test temperature: 20±15° C.
   Relative humidity: 45 to 85%
   Agitation time: 2 sec
   Standstill time: 10 min
   Repeating time: 8 hour

Notably, 8 types of sand as specified by JIS Z 8901 were obtained from the loamy layer of the Kanto district of Japan; intermediate grain size is 6.6 to 8.6 μm.

TABLE 2
Result of dust test (n = 5)

| | Loading | Eject |
|---|---|---|
| Ex. 1 | Δ (2/5) | ∘ (4/5) |
| Comp. Ex. 1 | x (0/5) | x (0/5) |

∘: 80% or more of operations were successful
Δ: 21% to 79% of operations were successful
x: 20% or less of operations were successful

### Examples 2 to 4

Cylindrical bodies of Examples 2 to 4 were molded from silicone rubber (100 parts by weight) by use of different molds for Examples 2 to 4, each having undergone sand blasting and having a predetermined shape. Specifically, the silicone rubber was subjected to vulcanization performed at 170° C. for 8 min by use of a heating press, whereby cylindrical bodies each having a Shore A hardness of 50° were obtained. Each cylindrical body was then cut off to thereby obtain a disc-loading roll of each of Examples 2 to 4.

### Comparative Example 2

Molding was performed by use of a rubber material similar to that used in Examples 2 to 4 and a mold having a mirror-like inner surface to thereby obtain a disc-loading roll of Comparative Example 2.

### Test Example 3

The surface conditions of the outer surfaces of the disc-loading rolls of Example 2 to 4 and Comparative Example 2 were measured in the following manner.

A VIOLET LASER COLOR 3D PROFILE MICROSCOPE of Keyence Corporation (controller section: VK-9500, measuring section: VK-9510, profile analyzing application: VK-H1A9 (Ver. 2.2) for 3D measurement/surface area) was used as a measurement instrument. The measurement was performed under the following conditions.
Magnification: 3000×(objective 150×20)
Optical zoom: 1×
Color super depth
Measurement distance for Rz and Sm: 50 μm
Measurement area for Ry: 500 μm² (10×50)
Pitch: 0.0.05 μm
Height smoothing: ±2
Surface inclination correction: auto
Cut-off value: 0.08 mm
Filtering: smoothing (three times)

For each of the disc-loading rolls of Examples 2 to 4 and Comparative Example 2, sampling data were acquired at six locations, and the maximum value, minimum value, and mean value were obtained.

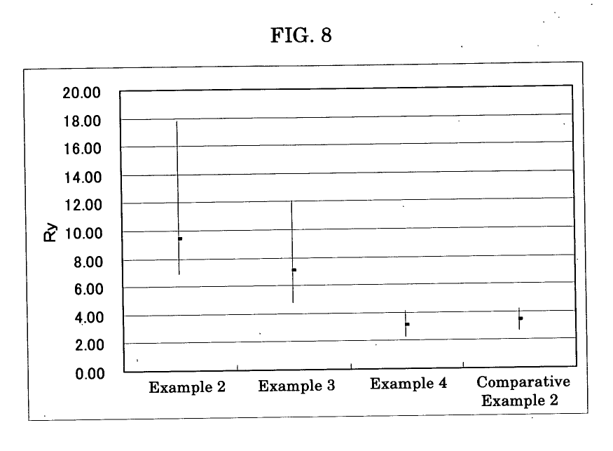

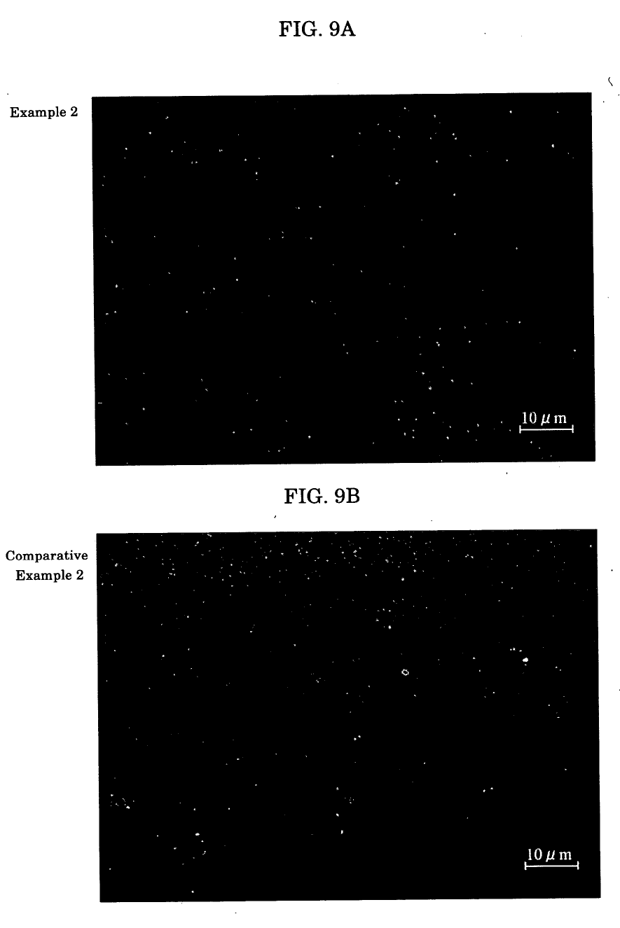

The results are shown in Table 3. Ry is shown in FIG. 8 as well. As to Example 2 and Comparative Example 2, photographs (3000×) of surfaces are shown in FIGS. 9A and 9B.

The results show that whereas the loading roll of Comparative Example 2 has gentle irregularities, the loading rolls of Example 2 and 3 each have irregularities whose intervals are small, and whose surface maximum height Ry is large; i.e., Examples 2 and 3 clearly differ from Comparative Example 2 in terms of surface conditions. The results clearly show that between Comparative Example 2 and Examples 2 and 3 no difference is present in surface roughness Rz, but significant differences are present in mean irregularity interval Sm and the maximum height Ry.

TABLE 3

| | Surface roughness | | | | | | | | | Results of | |
|---|---|---|---|---|---|---|---|---|---|---|---|
| | Ry [n = 6] (μm) | | | Rz [n = 6] (μm) | | | Sm [n = 6] (μm) | | | Dust Test | |
| | Max | Min | Mean | Max | Min | Mean | Max | Min | Mean | Loading | Eject |
| Ex. 2 | 17.80 | 6.85 | 9.44 | 1.50 | 0.68 | 1.09 | 9.85 | 1.66 | 4.85 | Δ (5/10) | ∘ (8/10) |
| Ex. 3 | 12.10 | 4.80 | 7.09 | 2.06 | 0.79 | 1.27 | 10.22 | 1.35 | 6.20 | Δ (3/10) | Δ (7/10) |
| Ex. 4 | 4.12 | 2.24 | 3.12 | 1.50 | 0.34 | 0.99 | 13.87 | 3.35 | 6.23 | Δ (2/10) | Δ (4/10) |
| Comp. Ex. 2 | 4.24 | 2.65 | 3.43 | 1.84 | 0.41 | 0.85 | 33.4 | 5.35 | 17.5 | x (0/10) | x (0/10) |

### Test Example 4

The loading and eject operation test was performed in the same manner as in Test Example 2, while the disc-loading rolls of Examples 2 to 4 and Comparative Example 2 were used. Notably, 20 disc-loading rolls of each of Examples 2 to 4 and Comparative Example 2 were manufactured. For each of Examples 2 to 4 and Comparative Example 2, the operation test was performed ten times while two rolls were used in each operation. The disc-loading rolls of Examples 2 to 4 and Comparative Example 2 were evaluated such that each roll was evaluated as good (◯) when 80% or more of the operations were successful, acceptable (Δ) when 20% to 79% of the operations were successful, and not good (x) when less than 20% of operations were successful. The results are shown in Table 3. As is apparent from Table 3, Examples 2 and 3 whose Ry, Rz, and Sm values fall within the respective predetermined ranges realize considerably improved loading and eject operations as compared with the case of Comparative Example 2. Further, Examples 2 and 3 realize better loading and eject operations as compared with the case of Example 4 whose Rz and Sm values fall within the respective ranges of the present invention, but whose average Ry value falls outside the range of 4 to 18 μm.

### Examples 5 to 9

Cylindrical bodies of Examples 5 to 9 were molded from silicone rubber (100 parts by weight) by use of different molds for Examples 5 to 9, each having undergone sand blasting and having a predetermined shape. Specifically, the silicone rubber was subjected to vulcanization performed at 170° C. for 8 min by use of a heating press, whereby cylindrical bodies each having a Shore A hardness of 50° were obtained. Each cylindrical body was then cut off to thereby obtain a disc-loading roll of each of Examples 5 to 9.

### Comparative Example 3

Molding was performed by use of a rubber material similar to that used in Example 5 and a mold having a mirror-like inner surface to thereby obtain a disc-loading roll of Comparative Example 3.

### Test Example 4

The surface conditions of the outer surfaces of the disc-loading rolls of Examples 5 to 9 and Comparative Example 3 were measured in the same manner as in Test Example 3, while the measurement distance for tp was also set to 50 μm. For each of the disc-loading rolls of Examples 5 to 9 and Comparative Example 3, sampling data were acquired at a single location for tp; and sampling data were acquired at six locations for Rz and Sm, and the maximum value, minimum value, and mean value were obtained.

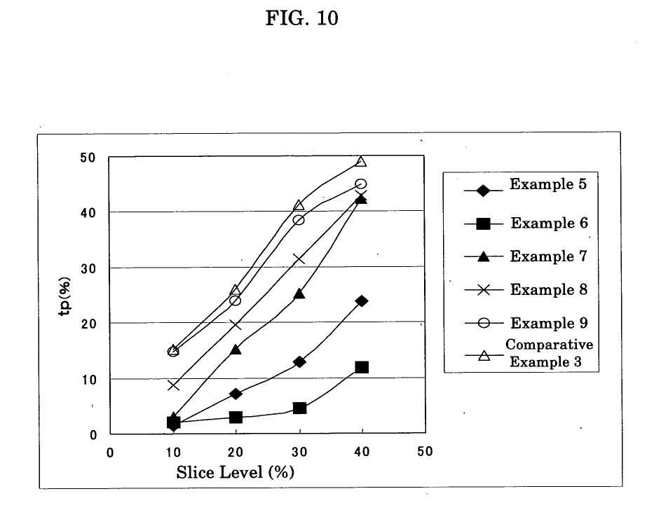

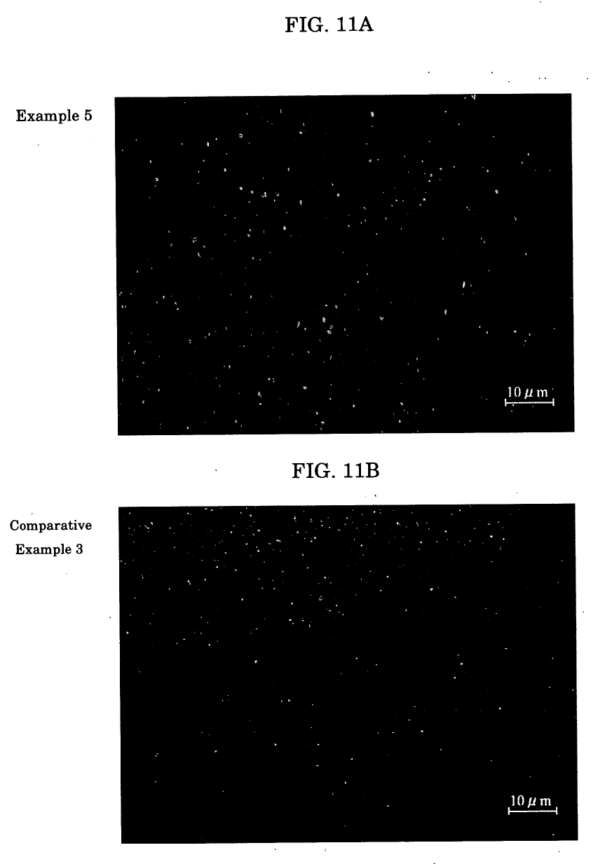

Table 4 shows results of measurements for surface roughness Rz, average irregularity interval Sm, and tp at slice levels of 10 to 40%. The values of tp are shown in FIG. 10 as well. As to Example 5 and Comparative Example 3, photographs (3000×) of surfaces are shown in FIGS. 11A and 11B.

The results show that whereas the loading roll of Comparative Example 3 has gentle irregularities, the loading rolls of Example 5 to 7 each have irregularities whose intervals are small and whose tp value at each slice level is small (i.e., provide wider spaces in which dust particles fall); that is, Examples 5 to 7 clearly differ from Comparative Example 3 in terms of surface conditions. The results clearly show that between Comparative Example 3 and Examples 5 to 7 no difference is present in surface roughness Rz, but significant differences are present in mean irregularity interval Sm and material ratio tp.

TABLE 4

| | | | | | | | | | | | Operation Test | |
|---|---|---|---|---|---|---|---|---|---|---|---|---|
| | | | | | | | | | | | Results of | |
| | tp (%) | | | | | | | | | | Dust Test | |
| | Slice level (%) | | | | Rz [n = 6] (μm) | | | Sm [n = 6] (μm) | | | (n = 10) | |
| | 10 | 20 | 30 | 40 | Max | Min | Mean | Max | Min | Mean | Loading | Eject |
| Ex. 5 | 1.50 | 7.10 | 12.80 | 23.80 | 1.55 | 0.79 | 1.08 | 7.22 | 1.41 | 4.21 | Δ (4/10) | ∘ (8/10) |
| Ex. 6 | 2.00 | 2.90 | 4.60 | 11.90 | 1.42 | 0.63 | 1.28 | 9.85 | 1.35 | 4.39 | Δ (5/10) | ∘ (8/10) |
| Ex. 7 | 3.10 | 15.20 | 25.30 | 42.30 | 1.36 | 0.68 | 1.01 | 8.26 | 1.20 | 4.28 | Δ (4/10) | Δ (6/10) |
| Ex. 8 | 8.80 | 19.60 | 31.50 | 42.90 | 1.48 | 0.34 | 1.00 | 10.26 | 1.95 | 4.58 | Δ (3/10) | Δ (4/10) |
| Ex. 9 | 14.70 | 24.00 | 38.50 | 44.90 | 1.01 | 0.28 | 0.61 | 11.02 | 2.09 | 5.25 | Δ (3/10) | Δ (4/10) |
| Comp. | 15.22 | 26.00 | 41.30 | 49.00 | 1.74 | 0.28 | 0.74 | 38.44 | 9.96 | 15.67 | x (0/10) | x (0/10) |
| Ex. 3 | | | | | | | | | | | | |

### Test Example 5

The loading and eject operation test was performed in the same manner as in Test Example 4, while each of the disc-loading rolls of Examples 5 to 9 and Comparative Example 3 was used. The results are shown in Table 4. As is apparent from Table 4, Examples 5 to 7, whose tp, Rz, and Sm values fall within the respective predetermined ranges, realize considerably improved loading and eject operations as compared with the case of Comparative Example 3. Further, Examples 5 to 7 realize better loading and eject operations as compared with the case of Examples 8 and 9, whose Rz and Sm values fall within the respective ranges of the present invention, but whose tp value at each slice level is large and whose irregular surface has broad peaks.

### Examples 10 and 11

Cylindrical bodies of Examples 10 to 11 were molded from silicone rubber (100 parts by weight) by use of different molds for Examples 10 and 11, each having undergone sand blasting and having a predetermined shape. Specifically, the silicone rubber was subjected to vulcanization performed at 170° C. for 8 min by use of a heating press, whereby cylindrical bodies each having a Shore A hardness of 50° were obtained. Each cylindrical body was then cut off to thereby obtain a disc-loading roll of each of Examples 10 and 11.

### Comparative Examples 4 and 5

Disc-loading rolls of Comparative Examples 4 and 5 were molded by use of a rubber material similar to that used in Example 10 and a mold having a mirror-like inner surface.

### Test Example 6

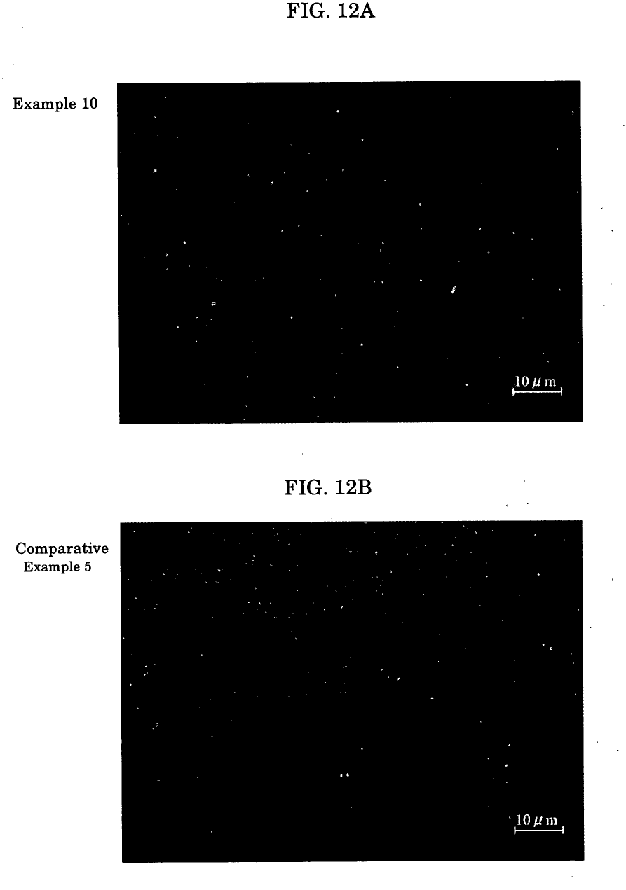

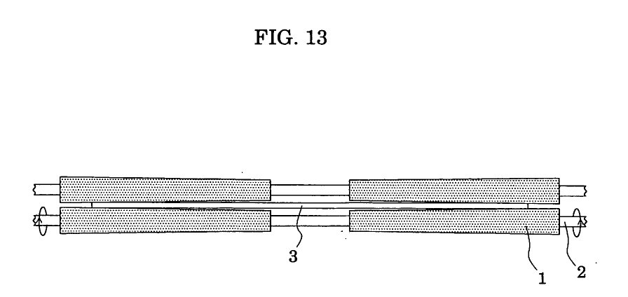

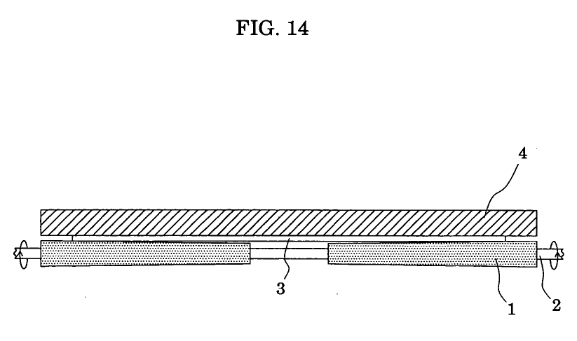

The surface conditions of the outer surfaces of the disc-loading rolls of Examples 10 and 11 and Comparative Examples 4 and 5 were measured in the same manner as in Test Example 3, while the reference area was set to 6600 μm For each of the disc-loading rolls of Examples 10 and 11 and Comparative Examples 4 and 5, sampling data were acquired at a single location for surface area; and sampling data were acquired at five locations for Rz and Sm, and the maximum value, minimum value, and mean value were obtained. Table 5 shows the results. As to Example 10 and Comparative Example 5, photographs (3000×) of surfaces are shown in FIGS. 12A and 12B.

The results show that whereas the loading rolls of Comparative Examples 4 and 5 have gentle irregularities, the loading rolls of Example 10 and 11 each have small irregularity intervals and a surface area-to-reference area ratio greater than 1.9, whereby the surface area becomes two times or more because of presence of irregularities; that is, Examples 10 and 11 clearly differ from Comparative Examples 4 and 5 in terms of surface conditions. The results clearly show that between Comparative Examples 4 and 5 and Examples 10 and 11 no difference is present in surface roughness Rz, but significant differences are present in mean irregularity interval Sm and surface area-to-reference-area ratio.

TABLE 5

| | | | | | | | Surface | | |
|---|---|---|---|---|---|---|---|---|---|
| | Rz [n = 5] (μm) | | | Sm [n = 5] (μm) | | | area/Ref. | Operation Test | |
| | Max | Min | Mean | Max | Min | Mean | area | Loading | Eject |
| Ex. 10 | 1.61 | 0.68 | 1.12 | 8.05 | 1.58 | 3.89 | 2.3 | Δ (5/10) | Δ (7/10) |
| Ex. 11 | 1.29 | 0.54 | 0.85 | 7.28 | 3.24 | 4.09 | 2.1 | Δ (4/10) | Δ (6/10) |
| Comp. Ex. 4 | 1.35 | 0.84 | 1.01 | 31.33 | 13.2 | 18.21 | 1.9 | x (0/10) | x (1/10) |
| Comp. Ex. 5 | 1.23 | 0.35 | 0.84 | 29.28 | 12.56 | 17.02 | 1.6 | x (0/10) | x (0/10) |

### Test Example 7

The loading and eject operation test was performed in the same manner as in Test Example 4, while each of the disc-loading rolls of Examples 10 and 11 and Comparative Example 4 and 5 was used. The results are shown in Table 5. As is apparent from Table 5, Examples 10 to 11 realize better loading and eject operations as compared with the case of Comparative Examples 4 and 5 whose average Sm value and surface area-to-reference area ratio fall outside the respective ranges of the present invention.

1. A disc-loading roll composed of a rubber elastic body formed by use of a mold and having a cylindrical outer circumferential surface whose diameter changes along an axial direction, the disc-loading roll coming into contact with a peripheral edge portion of a disc so as to load the disc, wherein the outer circumferential surface of the roll is an irregular surface which is formed by means of the mold, and the irregular surface has a ten-point mean roughness Rz of 0.5 to 10 μm and a mean irregularity interval Sm of 15 μm or less.

2. A disc-loading roll according to claim 1, wherein the irregular surface has a mean area maximum height Ry of 4 to 18 μm.

3. A disc-loading roll according to claim 1, wherein the irregular surface has a material ratio tp of 16% or less at a slice level of 20%, and 26% or less at a slice level of 30%.

4. A disc-loading roll according to claim 1, wherein the ratio of a surface area of the irregular surface to an apparent surface area of the roll surface determined under the assumption that the roll surface is a mirror-finished surface is higher than 1.9.

5. A disc-loading roll according to claim 1, wherein the rubber elastic body has a Shore A hardness of 30 to 90°.
